(19) United States
(12) Patent Application Publication
(10) Pub. No.: US 2016/0147068 A1
(43) Pub. Date: May 26, 2016

(54) VIRTUAL IMAGE DISPLAY APPARATUS

(71) Applicant: Coretronic Corporation, Hsin-Chu (TW)

(72) Inventors: Chung-Ting Wei, Hsin-Chu (TW); Chi-Tang Hsieh, Hsin-Chu (TW); Tzu-Hua Huang, Hsin-Chu (TW)

(21) Appl. No.: 14/788,811

(22) Filed: Jul. 1, 2015

(30) Foreign Application Priority Data
Nov. 26, 2014 (TW) 103140969

(51) Int. Cl. G02B 27/01; G02B 13/16; G02B 27/10

(52) U.S. Cl. CPC G02B 27/0172; G02B 27/1066; G02B 13/16; G02B 2027/011; G02B 2027/0118

(57) ABSTRACT

A virtual image display apparatus configured to be disposed in front of an eye of a user is provided. The virtual image display apparatus includes an image displaying unit providing an image beam, a first beam splitting unit disposed on the transmission path of the image beam, and an image correction unit disposed on the transmission path of the image beam from the first beam splitting unit. The image correction unit includes a first optical element, a second optical element, and a planar reflective element. The image beam emitted by the image displaying unit sequentially travels through the first beam splitting unit, the first optical element, and the second optical element, and is reflected by the planar reflective element, then travels through the second optical element and the first optical element again, and is transmitted to the eye by the first beam splitting unit.

### CROSS-REFERENCE TO RELATED APPLICATION

This application claims the priority benefit of Taiwan application serial no. 103140969, filed on Nov. 26, 2014. The entirety of the above-mentioned patent application is hereby incorporated by reference herein and made a part of this specification.

### BACKGROUND OF THE INVENTION

1. Field of the Invention

The invention relates to a display apparatus, and particularly to a virtual image display apparatus.

2. Description of Related Art

With the advances in display technologies and related fields, different types of display apparatuses have been invented. In these display apparatuses, the head-mounted display (HMD) is viewed as a major focus for the development of display technology due to its usage convenience and privacy. Moreover, as cloud technologies mature and the resolution of the micro-display apparatus increases as its size and power consumption decreases, the head-mounted display is being developed into a portable display apparatus.

Generally speaking, the head-mounted display usually adopts the near-eye display (NED) to transmit the image beam outputted from the micro-display apparatus to the eyes of the user. Since the head-mounted display is worn on the head, the near-eye display needs to be thin and small in order to reduce the discomfort when worn by the user. However, if the optical system of the near-eye display is improperly simplified to reduce the weight and size of the head-mounted display, the image quality of the head-mounted display is affected. Therefore, how to maintain the image quality of the head-mounted display while keeping the device small and thin is one of the important topics.

U.S. Publication No. 20130147685, Taiwan Publication No. 201426005, and China Patent No. 100565250 respectively disclosed different head-mounted displays.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The invention is directed to a head-mounted display capable of maintaining image quality and meeting the demands small size and light weight.

Other objectives and advantages of the invention will be further understood from the technological features disclosed by the embodiments of the invention.

In order to achieve one or some or all of these purposes or any other purposes, an embodiment of the invention provides a virtual image display apparatus configured to be disposed in front of an eye of a user. The virtual image display apparatus includes an image displaying unit, a first beam splitting unit, and an image correction unit. The image displaying unit provides an image beam. The first beam splitting unit is disposed on a transmission path of the image beam. The image correction unit is disposed on the transmission path of the image beam from the first beam splitting unit. The first beam splitting unit transmits at least a part of the image beam from the image correction unit to the eye. The image correction unit includes a first optical element, a second optical element, and a planar reflective element. The image beam emitted by the image displaying unit sequentially travels through the first beam splitting unit, the first optical element, and the second optical element, and is reflected by the planar reflective element, then travels through the second optical element and the first optical element again, and is transmitted to the eye by the first beam splitting unit.

In an embodiment of the invention, the first beam splitting unit allows at least a part of the image beam emitted by the image displaying unit to pass through and be transmitted to the image correction unit, and the first beam splitting unit reflects at least the part of the image beam reflected by the image correction unit to the eye.

In an embodiment of the invention, the first beam splitting unit is a partially transmissive partially reflective beam splitting element.

In an embodiment of the invention, one of the first optical element and the second optical element has a positive dioptre, and the other one of the first optical element and the second optical element has a negative dioptre.

In an embodiment of the invention, the first optical element and the second optical element are respectively formed by a lens or a lens group.

In an embodiment of the invention, one of the first optical element and the second optical element is a biconvex lens or a plano-convex lens, and the other one of the first optical element and the second optical element is a biconcave lens or a plano-concave lens.

In an embodiment of the invention, the first optical element, the second optical element, and the planar reflective elective do not directly contact each other.

In an embodiment of the invention, a transmission medium of the image beam emitted by the image displaying unit between the image displaying unit and the first beam splitting unit is air.

In an embodiment of the invention, a transmission medium of the image beam emitted by the image displaying unit between the image displaying unit and the first beam splitting unit is a transparent solid-state material, and the transparent solid-state material is plastic or glass.

In an embodiment of the invention, the image displaying unit comprises a light source module, a micro-reflective display panel, and a second beam splitting unit. The light source module provides an illumination beam. The second beam splitting unit transmits at least a part of the illumination beam emitted by the light source module to the micro-reflective display panel. The micro-reflective display panel reflects at least the part of the illumination beam from the second beam splitting unit and converts at least the part of the illumination beam into the image beam, and the second beam splitting unit transmits at least a part of the image beam from the micro-reflective display panel to the first beam splitting unit.

In an embodiment of the invention, the micro-reflective display panel is a liquid crystal on silicon panel or a digital micro-mirror device, and the second beam splitting unit is a polarizing beam splitter or a partially transmissive partially reflective beam splitting element.

In order to achieve one or some or all of these purposes or any other purposes, another embodiment of the invention provides a virtual image display apparatus configured to be disposed in front of an eye of a user. The virtual image display apparatus includes an image displaying unit, a first beam splitting unit, and an image correction unit. The image displaying unit provides an image beam. The first beam splitting unit is disposed on a transmission path of the image beam. The image correction unit is disposed on the transmission path of the image beam. The first beam splitting unit transmits at least a part of the image beam from the image correction unit to the eye. The image correction unit includes a first optical element, a second optical element, and a planar reflective element. The image beam emitted by the image displaying unit sequentially travels through the first optical element, the first beam splitting unit, and the second optical unit, and is reflected by the planar reflective element, then travels through the second optical element again, and is transmitted to the eye by the first beam splitting unit.

In an embodiment of the invention, the first optical element is disposed between the image displaying unit and the first beam splitting unit. The first beam splitting unit allows at least a part of the image beam from the first optical element to pass through and be transmitted to the second optical element, and the first beam splitting unit reflects at least the part of the image beam from the second optical element to the eye.

In an embodiment of the invention, the first beam splitting unit is a partially transmissive partially reflective beam splitting element.

In an embodiment of the invention, both of the first optical element and the second optical element have a positive dioptre.

In an embodiment of the invention, the second optical element is formed by a lens or a lens group.

In an embodiment of the invention, the first optical element is a diffractive optical element, and the second optical element is a biconvex lens or a plano-convex lens.

In an embodiment of the invention, the first optical element, the second optical element, and the planar reflective elective do not directly contact each other.

In an embodiment of the invention, a transmission medium of the image beam emitted by the image displaying unit between the image displaying unit and the first beam splitting unit is air.

In an embodiment of the invention, a transmission medium of the image beam emitted by the image displaying unit between the image displaying unit and the first beam splitting unit is a transparent solid-state material, and the transparent solid-state material is plastic or glass.

In an embodiment of the invention, the image displaying unit comprises a light source module, a micro-reflective display panel, and a second beam splitting unit. The light source module provides an illumination beam. The second beam splitting unit transmits at least a part of the illumination beam emitted by the light source module to the micro-reflective display panel. The micro-reflective display panel reflects at least the part of the illumination beam from the second beam splitting unit and converts at least the part of the illumination beam into the image beam, and the second beam splitting unit transmits at least a part of the image beam from the micro-reflective display panel to the first beam splitting unit.

In an embodiment of the invention, the micro-reflective display panel is a liquid crystal on silicon panel or a digital micro-mirror device, and the second beam splitting unit is a polarizing beam splitter or a partially transmissive partially reflective beam splitting element.

In the virtual image display apparatus according to embodiments of the invention, the image correction unit satisfies the demands of light weight and small size, and the image correction unit enhances image resolution and corrects the chromatic aberration. Therefore, the virtual image display apparatus according to embodiments of the invention can maintain image quality and meet the demands of light weight and small size.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top schematic view of a virtual image display apparatus according to a first embodiment of the invention.

FIG. 2 is a top schematic view of a virtual image display apparatus according to a second embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

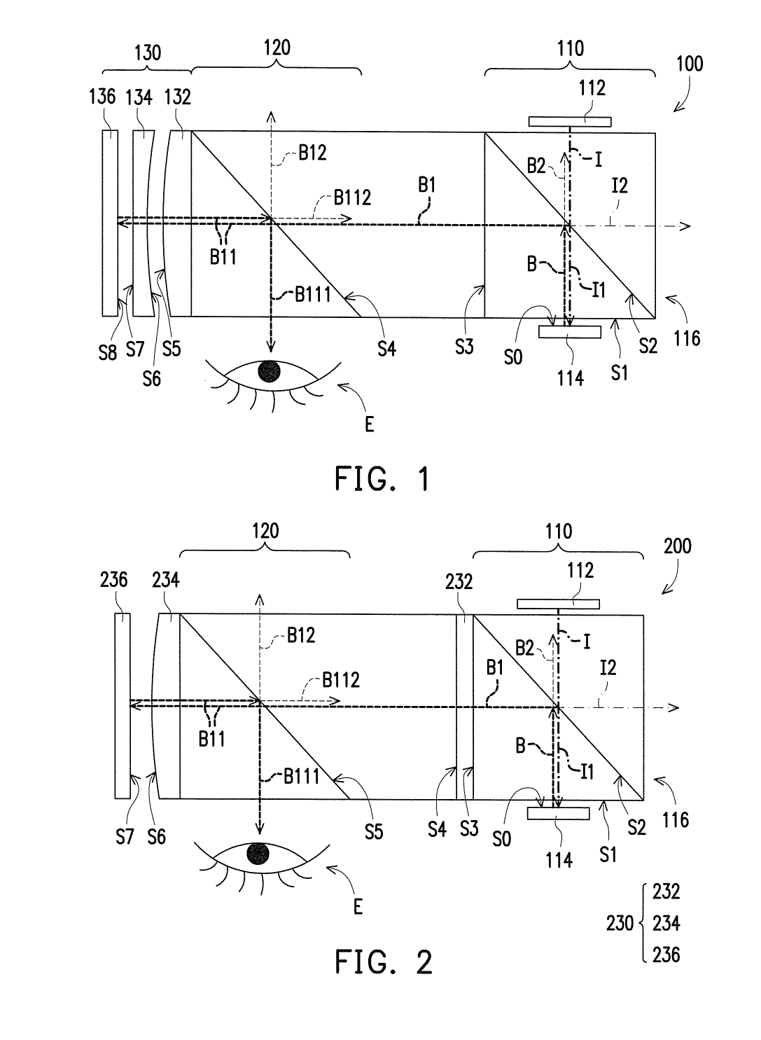

FIG. 1 is a top schematic view of a virtual image display apparatus according to a first embodiment of the invention. With reference to FIG. 1, a virtual image display apparatus 100 is configured to be disposed in front of an eye E of a user. The virtual image display apparatus 100 includes an image displaying unit 110, a first beam splitting unit 120, and an image correction unit 130. The image displaying unit 110 provides an image beam B1. The first beam splitting unit 120 is disposed on a transmission path of the image beam B1. The image correction unit 130 is disposed on a transmission path of an image beam B11 from the first beam splitting unit 120, and the first beam splitting unit 120 transmits at least a part of the image beam (e.g. image beam B111) from the image correction unit 130 to the eye E.

The image displaying unit 110 may be a micro-display such as a liquid crystal display, an organic light-emitting diode display, a spatial light modulator, or other suitable displays. In one embodiment, as shown in FIG. 1, the image displaying unit 110 may include a light source module 112, a micro-reflective display panel 114, and a second beam splitting unit 116.

The light source module 112, may exemplarily including a light emitting diode, provides an illumination beam I. The light source module 112 may be a direct-light type light source module or a side-incident type light source module (used with a light guide plate), however, the invention is not limited thereto, and the light source module 112 may be other types of light source modules. The second beam splitting unit 116 is disposed on a transmission path of the illumination beam I, and the second beam splitting unit 116 is suitable for transmitting at least a part of the illumination beam (e.g. illumination beam I1) emitted from the light source module 112 to the micro-reflective display panel 114. Specifically, in one embodiment, after the illumination beam I is transmitted to the second beam splitting unit 116, the illumination beam I may be divided into the illumination beam I1 transmitting through the second beam splitting unit 116 and the illumination beam I2 reflected by the second beam splitting unit 116. In the present embodiment, the second beam splitting unit 116 may be a polarizing beam splitter (PBS) which splits a beam according to its polarization states. For example, the polarizing beam splitter may allow most of the p-polarized beams to pass through and reflect most of the s-polarized beams. Therefore, when the illumination beam I includes p-polarization states and s-polarization states, the illumination beam I1 transmitting through the second beam splitting unit 116 is mostly p-polarized with a minority being s-polarized. On the other hand, the illumination beam I2 reflected by the second beam splitting unit 116 is mostly s-polarized with a minority being p-polarized. It should be noted that, the second beam splitting unit 116 is not limited to the polarizing beam splitter. For example, the second beam splitting unit 116 may be a partially transmissive partially reflective beam splitting element that allows a part of the illumination beam I1 to transmit through and reflects a part of the illumination beam I2. In one embodiment, the image displaying unit 110 may further include a polarizer disposed between the second beam splitting unit 116 and the light source module 112, so that the illumination beam I has only one type of polarization state.

The micro-reflective display panel 114 is disposed on a transmission path of at least a part of the illumination beam (e.g. one of illumination beam I1 and illumination beam I2) from the second beam splitting unit 116. The micro-reflective display panel 114 is suitable for reflecting at least a part of an illumination beam from the second beam splitting unit 116 and converting the part of the illumination beam into the image beam B. A polarizer may be configured to suitably change the polarization state of the beam. The micro-reflective display panel 114 may be, for example, a liquid crystal on silicon (LCOS) panel or a digital micro-mirror device (DMD).

In the present embodiment as shown in FIG. 1, the micro-reflective display panel 114 is disposed on the transmission path of the illumination beam I1 transmitting through the second beam splitting unit 116. In other words, the light source module 112 and the micro-reflective display panel 114 are respectively located on two opposite sides of the second beam splitting unit 116. In another embodiment, the micro-reflective display panel 114 may be disposed on a transmission path of the illumination beam I2 reflected by the second beam splitting unit 116. That is, the light source module 112 and the micro-reflective display panel 114 are respectively located on two adjacent sides of the second beam splitting unit 116. In other embodiments, the locations of the light source module 112, the second beam splitting unit 116, and the micro-reflective display panel 114 may be configured according to suitable optical path designs, and the invention is not limited thereto.

In addition to converting the illumination beam I1 into the image beam B, the micro-reflective display panel 114 can also convert the polarization state of light, such that the second beam splitting unit 116 can transmit most of the image beam (e.g. image beam B1) from the micro-reflective display panel 114 to the first beam splitting unit 120. For example, the micro-reflective display panel 114 is able to convert p-polarization state into s-polarization state, and convert s-polarization state into p-polarization state. In other words, after operation of the micro-reflective display panel 114, the illumination beam I1 formed mainly with p-polarization state is converted into the image beam B formed mainly with s-polarization state. According to the foregoing beam splitting principle of the polarizing beam splitter, the second beam splitting unit 116 reflects most of the s-polarized beam and transmits most of the p-polarized beam. In the present embodiment, most of the image beam B from the micro-reflective display panel 114 is reflected by the second beam splitting unit 116 and emitted toward the first beam splitting unit 120 from the image displaying unit 110. It should be noted that, after the image beam B is transmitted to the second beam splitting unit 116, the image beam B is divided into the image beam B1 reflected by the second beam splitting unit 116 and the image beam B2 transmitted through the second beam splitting unit 116, in which the reflected image beam B1 may be s-polarized, and the transmitted image beam B2 may be p-polarized.

The first beam splitting unit 120 is disposed on the transmission path of the image beam B1 emitted by the image displaying unit 110. In the present embodiment, a transmission medium of the image beam B1 emitted by the image displaying unit 110 between the image displaying unit 110 and the first beam splitting unit 120 may be a transparent solid-state material, in which the transparent solid-state material may be plastic or glass. As shown in FIG. 1, the image displaying unit 110 and the first beam splitting unit 120 of the present embodiment may be joined together by the transparent solid-state material (e.g. plastic or glass). The image beam B1 is transmitted in a connected portion of the first beam splitting unit 120 and the image displaying unit 110. In another embodiment, the image displaying unit 110 and the first beam splitting unit 120 may be structurally separated. That is, the image displaying unit 110 and the first beam splitting unit 120 are only positioned by mechanical elements (not drawn) and not joined by plastic or glass. Accordingly, a transmission medium of the image beam B1 emitted by the image displaying unit 110 between the image displaying unit 110 and the first beam splitting unit 120 may be air (not shown).

The first beam splitting unit 120 may be a partially transmissive partially reflective beam splitting element. After the image beam B1 is transmitted to the first beam splitting unit 120, the image beam B1 may be divided into the image beam B11 transmitting through the first beam splitting unit 120 and an image beam B12 reflected by the first beam splitting unit 120. In the present embodiment, the first beam splitting unit 120 allows at least a part of the image beam (e.g. image beam B11) emitted by the image displaying unit 110 to pass through and be transmitted to the image correction unit 130. In other words, the image correction unit 130 is disposed on the transmission path of the image beam B11.

The image correction unit 130 includes a first optical element 132, a second optical element 134, and a planar reflective element 136. The first optical element 132 and the second optical element 134 are suitable for enhancing the resolution of the virtual image display apparatus 100. Moreover, the dioptre of one of the first optical element 132 and the second optical element 134 may be a positive value, while the other one may be a negative value. Accordingly, the first optical element 132 and the second optical element 134 may also help correct the chromatic aberration generated by the image beam B11 travelling through the first beam splitting unit 120 and the second beam splitting unit 116.

The first optical element 132 and the second optical element 134 may be respectively formed by a lens or a lens group. When the first optical element 132 and the second optical element 134 are respectively formed by a single lens, a lens having a positive dioptre may be a biconvex lens or a plano-convex lens, and a lens having a negative dioptre may be biconcave lens or a plano-concave lens. Although the first optical element 132 is depicted as a positive lens (i.e. the dioptre is a positive value) and the second optical element 134 is depicted as a negative lens (the dioptre is a negative value) in FIG. 1, the invention is not limited thereto. In another embodiment, the first optical element 132 may be a negative lens, and the second optical element 134 may be a positive lens.

The planar reflective element 136 is suitable for reflecting the image beam B11 from the first beam splitting unit 120 that travels through the first optical element 132 and the second optical element 134 back to the first beam splitting unit 120. The planar reflective element 136 may be a plane mirror, although not limited thereto. For example, the planar reflective element 136 may be a planar element with the surface coated with reflective material.

As shown in FIG. 1, the first optical element 132 may be joined with the first beam splitting unit 120. The first optical element 132, the second optical element 134, and the planar reflective element 136 do not directly contact each other. The image beam B1 emitted by the image displaying unit 110 sequentially travels through the first beam splitting unit 120, the first optical element 132, and the second optical element 134, and is reflected by the planar reflective element 136, then travels through the second optical element 134 and the first optical element 132 again, and is transmitted to the eye E of the user by the first beam splitting unit 120. In the present embodiment, after the image beam B11 reflected by the planar reflective element 136 of the image correction unit 130 is transmitted to the first beam splitting unit 120, the image beam B11 is divided into the image beam B111 reflected by the first beam splitting unit 120 and an image beam B112 transmitting through the first beam splitting unit 120, in which the first beam splitting unit 120 reflects the portion of the image beam (e.g. image beam B111) reflected by the image correction unit 130 to the eye E of the user.

The embodiment as shown in FIG. 1 uses three elements to form the image correction unit 130 in order to enhance the resolution and to correct for chromatic aberration. Since assembly of the elements in the image correction unit 130 is simple and requirements such as light weight and small size can be met, the virtual image display apparatus 100 of the present embodiment can maintain image quality while satisfying the demands of light weight and small size.

Table 1 below lists one embodiment of design parameters for implementing the virtual image display apparatus 100 of FIG. 1, although the invention is not limited to the disclosure hereafter. In Table 1, the second beam splitting element 116 is, for example, a polarizing beam splitter (PBS), and surface S0 is a surface of the micro-reflective display panel 114 facing the second beam splitting unit 116. Surface S1 is a surface of the second beam splitting unit 116 facing the micro-reflective display panel 114. Surface S2 is a beam splitting surface of the second beam splitting unit 116. Surface S3 is a light exiting surface of the second beam splitting unit 116. Surface S4 is a beam splitting surface of the first beam splitting unit 120. Surface S5 is a surface of the first optical element 132 facing the second optical element 134. Surface S6 is a surface of the second optical element 134 facing the first optical element 132. Surface S7 is a surface of the second optical element 134 facing the planar reflective element 136. Surface S8 is a reflection surface of the planar reflective element 136 facing the second optical element 134.

In the column labelled “Distance between Surfaces”, 1 mm corresponding to surface S0 represents a distance between the surface S0 to surface S1, 3.75 mm corresponding to surface S1 represents a distance between surface S1 to surface S2. The distances corresponding to surface S2 to surface S7 can be similarly derived, and therefore further elaboration thereof is omitted hereafter. In the column labelled “Material”, N-BK7 is a glass material, and E48R is a plastic material. Moreover, an aspheric formula of an aspheric surface may be as shown in equation (1):

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} \qquad ( 1 )$$

in which z is the sagitta (SAG) of the aspheric surface, c is the curvature (i.e. reciprocal of the radius of curvature), r is the radial coordinate of the optical element, k is the conic constant, and α1, α2, and α3 are coefficients.

TABLE 1

| | | Radius of | Distance | | Conic | | | |
|---|---|---|---|---|---|---|---|---|
| | Surface | Curvature | between | | Constant | | | |
| Surface | Type | (mm) | Surfaces (mm) | Material | k | Coeff. α1 | Coeff. α2 | Coeff. α3 |
| S0 | Plane | ∞ | 1.00 | | | | | |
| S1 | Plane | ∞ | 3.75 | N-BK7 | | | | |
| S2 | Plane | ∞ | 3.75 | N-BK7 | | | | |
| S3 | Plane | ∞ | 16.00 | E48R | | | | |
| S4 | Plane | ∞ | 6.75 | E48R | | | | |
| S5 | Aspheric | 20.20 | 2.00 | | −2.08 | 0 | 3.21E−05 | 0 |
| S6 | Aspheric | 108.832 | 1.75 | E48R | 76.74 | 0 | 0 | 0 |
| S7 | Plane | ∞ | 1.50 | | | | | |
| S8 | Plane | ∞ | | | | | | |
| | (Mirror | | | | | | | |
| | Surface) | | | | | | | |

FIG. 2 is a top schematic view of a virtual image display apparatus according to a second embodiment of the invention. With reference to FIG. 2, a virtual image display apparatus 200 is similar to the virtual image display apparatus 100, and same elements are represented by the same reference numerals, with further elaboration thereof omitted. A main difference between the virtual image display apparatus 200 and the virtual image display apparatus 100 is the elements of the image correction unit and the relative configuration relationships thereof.

Specifically, an image correction unit 230 of the present embodiment includes a first optical element 232, a second optical element 234, and a planar reflective element 236. The first optical element 232 is disposed between the image displaying unit 110 and the first beam splitting unit 120, and the second optical element 234 and the planar reflective element 236 are disposed on a transmission path of at least a part of the image beam (e.g. image beam B11) from the first beam splitting unit 120. Therefore, the image beam B1 emitted by the image displaying unit 110 sequentially travels through the first optical element 232, the first beam splitting unit 120, and the second optical element 234, and is reflected by the planar reflective element 236, then travels through the second optical element 234 again, and is transmitted to the eye E of the user by the first beam splitting unit 120. In other words, the image beam transmitted from the image displaying unit 110 to the eye E of the user only travels through the first optical element 232 once.

The first optical element 232 is suitable for correcting optical aberration and chromatic aberration, for instance. Moreover, the combination of the first optical element 232 and the second optical element 234 optimizes the resolution. The first optical element 232 and the second optical element 234 have positive dioptres. In one embodiment, the first optical element 232 may be a diffractive optical element (DOE), and the second optical element 234 may be formed by a lens or a lens group. When the second optical element 234 is formed by a single lens such as a biconvex lens or a plano-convex lens, the planar reflective element 236 is suitable for reflecting the image beam B11 from the first beam splitting unit 120 that travels through the second optical element 234 back to the first beam splitting unit 120. The planar reflective element 236 may be a planar reflective mirror, although the invention is not limited thereto. For example, the planar reflective element 236 may be a planar element with the surface coated with reflective material.

As shown in FIG. 2, the present embodiment 230 uses three elements to form the image correction unit 230 in order to enhance the resolution and to correct chromatic aberration. Since assembly of the elements in the image correction unit 130 is simple and requirements such as light weight and small size can be met, the virtual image display apparatus 200 of the present embodiment can maintain image quality while satisfying the demands of light weight and small size.

Table 2 below lists one embodiment of design parameters for implementing the virtual image display apparatus 200 of FIG. 2, although the invention is not limited to the disclosure hereafter. The second beam splitting element 116 is, for example, a polarizing beam splitter (PBS). In Table 2, surface S0 is a surface of the micro-reflective display panel 114 facing the second beam splitting unit 116. Surface S1 is a surface of the second beam splitting unit 116 facing the micro-reflective display panel 114. Surface S2 is a beam splitting surface of the second beam splitting unit 116. Surface S3 is a light exiting surface of the second beam splitting unit 116. Surface S4 is a surface of the first optical element 232 facing the first beam splitting unit 120. Surface S5 is a beam splitting surface of the first beam splitting unit 120. Surface S6 is a surface of the second optical element 234 facing the planar reflective element 236. Surface S7 is a reflection surface of the planar reflective element 236 facing the second optical element 234.

In addition, a surface phase formula of the diffractive optical element may be represented by equation (2):

$$Φ = M {\sum }_{i = 1}^{N} {A}_{i} {ρ}^{2 i} \qquad ( 2 )$$

in which Φ is the phase distribution function, M is the diffraction order, N is the number of polynomial coefficients, Aᵢ is a coefficient, and ρ is the normalized radial aperture coordinate. In the present embodiment, the coefficient (e.g. A₁) of ρ² may be 7295, the coefficient (e.g. A₂) of ρ⁴ may be −1746, and the coefficient (e.g. A₃) of ρ⁶ may be −4201.

TABLE 2

| | | Radius of | Distance | |
|---|---|---|---|---|
| | Surface | Curvature | between | |
| Surface | Type | (mm) | Surfaces (mm) | Material |
| S0 | Plane | ∞ | 0.55 | |
| S1 | Plane | ∞ | 3.75 | N-BK7 |
| S2 | Plane | ∞ | 3.75 | N-BK7 |
| S3 | Plane | ∞ | 0.20 | |
| S4 | DOE | ∞ | 15.0 | E48R |
| S5 | Plane | ∞ | 6.75 | E48R |
| S6 | Plane | 23.15 | 1.00 | |

| | | |
|---|---|---|
| S7 | Plane | ∞ |
| | (Mirror | |
| | Surface) | |

The virtual image display apparatuses 100 and 200 may be applied in a head-mounted display. According to different requirements of use of the head-mounted display, one or two virtual image display apparatus 100 (or virtual image display apparatus 200) may be configured in the head-mounted display. When two virtual image display apparatuses 100 (or virtual image display apparatuses 200) are configured in the head-mounted display, the two virtual image display apparatuses 100 are respectively disposed in front of the left eye and the right eye of the user. When the head-mounted display provides a stereoscopic display function, the images received by the left eye and the right eye may have parallax, and the binocular parallax effect generated after both eyes respectively receive the images is used to form the stereoscopic visual sensation.

In summary, embodiments of the invention may achieve at least one of the following advantages or effects. In the virtual image display apparatus according to embodiments of the invention, the image correction unit satisfies the demands of light weight and small size, and the image correction unit enhances image resolution and corrects the chromatic aberration. Therefore, the virtual image display apparatus according to embodiments of the invention can maintain image quality and meet the demands of light weight and small size.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Furthermore, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A virtual image display apparatus configured to be disposed in front of an eye of a user, the virtual image display apparatus comprising:
an image displaying unit providing an image beam;
a first beam splitting unit disposed on a transmission path of the image beam; and
an image correction unit disposed on the transmission path of the image beam from the first beam splitting unit, and the first beam splitting unit transmits at least a part of the image beam from the image correction unit to the eye, the image correction unit comprising a first optical element, a second optical element, and a planar reflective element, the image beam emitted by the image displaying unit sequentially travels through the first beam splitting unit, the first optical element, and the second optical element, and is reflected by the planar reflective element, then travels through the second optical element and the first optical element again, and is transmitted to the eye by the first beam splitting unit.

2. The virtual image display apparatus according to claim 1, wherein the first beam splitting unit allows at least a part of the image beam emitted by the image displaying unit to pass through and be transmitted to the image correction unit, and the first beam splitting unit reflects at least the part of the image beam reflected by the image correction unit to the eye.

3. The virtual image display apparatus according to claim 1, wherein the first beam splitting unit is a partially transmissive partially reflective beam splitting element.

4. The virtual image display apparatus according to claim 1, wherein one of the first optical element and the second optical element has a positive dioptre, and the other one of the first optical element and the second optical element has a negative dioptre.

5. The virtual image display apparatus according to claim 1, wherein the first optical element and the second optical element are respectively formed by a lens or a lens group.

6. The virtual image display apparatus according to claim 1, wherein one of the first optical element and the second optical element is a biconvex lens or a plano-convex lens, and the other one of the first optical element and the second optical element is a biconcave lens or a plano-concave lens.

7. The virtual image display apparatus according to claim 1, wherein the first optical element, the second optical element, and the planar reflective elective do not directly contact each other.

8. The virtual image display apparatus according to claim 1, wherein a transmission medium of the image beam emitted by the image displaying unit between the image displaying unit and the first beam splitting unit is air.

9. The virtual image display apparatus according to claim 1, wherein a transmission medium of the image beam emitted by the image displaying unit between the image displaying unit and the first beam splitting unit is a transparent solid-state material, and the transparent solid-state material is plastic or glass.

10. The virtual image display apparatus according to claim 1, wherein the image displaying unit comprises a light source module, a micro-reflective display panel, and a second beam splitting unit, the light source module provides an illumination beam, the second beam splitting unit transmits at least a part of the illumination beam emitted by the light source module to the micro-reflective display panel, the micro-reflective display panel reflects at least the part of the illumination beam from the second beam splitting unit and converts at least the part of the illumination beam into the image beam, and the second beam splitting unit transmits at least a part of the image beam from the micro-reflective display panel to the first beam splitting unit.

11. The virtual image display apparatus according to claim 10, wherein the micro-reflective display panel is a liquid crystal on silicon panel or a digital micro-mirror device, and the second beam splitting unit is a polarizing beam splitter or a partially transmissive partially reflective beam splitting element.

12. A virtual image display apparatus configured to be disposed in front of an eye of a user, the virtual image display apparatus comprising:
an image displaying unit providing an image beam;
a first beam splitting unit disposed on a transmission path of the image beam; and
an image correction unit disposed on the transmission path of the image beam, and the first beam splitting unit transmits at least a part of the image beam from the image correction unit to the eye, the image correction unit comprising a first optical element, a second optical element, and a planar reflective element, the image beam emitted by the image displaying unit sequentially travels through the first optical element, the first beam splitting unit, and the second optical unit, and is reflected by the planar reflective element, then travels through the second optical element again, and is transmitted to the eye by the first beam splitting unit.

13. The virtual image display apparatus according to claim 12, wherein the first optical element is disposed between the image displaying unit and the first beam splitting unit, the first beam splitting unit allows at least a part of the image beam from the first optical element to pass through and be transmitted to the second optical element, and the first beam splitting unit reflects at least the part of the image beam from the second optical element to the eye.

14. The virtual image display apparatus according to claim 12, wherein the first beam splitting unit is a partially transmissive partially reflective beam splitting element.

15. The virtual image display apparatus according to claim 12, wherein both of the first optical element and the second optical element have a positive dioptre.

16. The virtual image display apparatus according to claim 12, wherein the second optical element is formed by a lens or a lens group.

17. The virtual image display apparatus according to claim 12, wherein the first optical element is a diffractive optical element, and the second optical element is a biconvex lens or a plano-convex lens.

18. The virtual image display apparatus according to claim 12, wherein the first optical element, the second optical element, and the planar reflective elective do not directly contact each other.

19. The virtual image display apparatus according to claim 12, wherein a transmission medium of the image beam emitted by the image displaying unit between the image displaying unit and the first beam splitting unit is air.

20. The virtual image display apparatus according to claim 12, wherein a transmission medium of the image beam emitted by the image displaying unit between the image displaying unit and the first beam splitting unit is a transparent solid-state material, and the transparent solid-state material is plastic or glass.

21. The virtual image display apparatus according to claim 12, wherein the image displaying unit comprises a light source module, a micro-reflective display panel, and a second beam splitting unit, the light source module provides an illumination beam, the second beam splitting unit transmits at least a part of the illumination beam emitted by the light source module to the micro-reflective display panel, the micro-reflective display panel reflects at least the part of the illumination beam from the second beam splitting unit and converts at least the part of the illumination beam into the image beam, and the second beam splitting unit transmits at least a part of the image beam from the micro-reflective display panel to the first beam splitting unit.

22. The virtual image display apparatus according to claim 21, wherein the micro-reflective display panel is a liquid crystal on silicon panel or a digital micro-mirror device, and the second beam splitting unit is a polarizing beam splitter or a partially transmissive partially reflective beam splitting element.
